(19) United States
(12) Patent Application Publication
(10) Pub. No.: US 2021/0289761 A1
(43) Pub. Date: Sep. 23, 2021

(54) SELF-MOVING ARTIFICIAL BAIT FISH AND METHOD FOR CONTROLLING A SELF-MOVING ARTIFICIAL BAIT FISH

(71) Applicant: Edmund PÖTSCH, Königsbrunn (DE)

(72) Inventor: Edmund PÖTSCH, Königsbrunn (DE)

(21) Appl. No.: 17/260,999

(22) PCT Filed: Jul. 23, 2019
(86) PCT No.: PCT/DE2019/100674

§ 371 Date: Jan. 16, 2021

(30) Foreign Application Priority Data
Jul. 24, 2018 (DE) 10 2018 117 801.8

(51) Int. Cl. A01K 85/16; A01K 85/01

(52) U.S. Cl. CPC A01K 85/16; A01K 85/01

(57) ABSTRACT

A self-movable artificial bait fish and to a method for controlling a self-movable artificial bait fish are disclosed. The self-movable artificial bait fish (1) comprises control means, a tail-end drive (330) and a head-end drive (340). The control means comprise at least one fastening means (130, 130′) for fastening a connecting line (10) to an angler (2), and the position of a fastening point (230) on the fastening means (130, 130′) in the direction of movement y can be arranged in the region from the rear extremity at the tail end (5) to a position behind the position of the drive point (220).

### TECHNICAL FIELD

The disclosure relates to a self-moving artificial bait fish and a method for controlling a self-moving artificial bait fish.

### BACKGROUND

A large number of artificial bait fish are used in fishing to replace the prohibited use of live bait fish. It is important to offer the artificial bait fish used to catch predatory fish as realistically as possible. Besides artificial bait fish, which are pulled through the water by the angler with the fishing line, also artificial bait fish are known, which move themselves by means of a drive in the water or at the water surface.

In the DE 039 211 56 A1, for example, such a drive consists of an electric motor mounted in the artificial lure fish with a propeller protruding from the artificial lure fish or a rotating fin which moves an artificial fishing lure through the water by means of a rotary movement, which is conventionally attached to the head in the front area of the body on the fishing line. Other drives known, for example, from DE 197 223 68 A1 or DE 10 2008 019 315 A1 convert the rotary movement of the electric motor into an oscillating movement of the tail fin by means of an eccentric device, whereby essentially a lifelike drive movement is to be imitated.

The disadvantage is that the self-moving artificial bait fish makes an unnatural uniform movement due to the rotation of the motor and the propeller, which does not fit into the experience pattern of predatory fish and rather discourages than attracts them. The engine, a propeller or a gearbox or an eccentric conversion mechanism also generate unnatural vibrations in the form of noises or vibrations, which deter a predator fish because it does not recognize any supposed prey in the artificial bait fish, but rather a foreign body. Fish react very sensitively to unnatural vibrations via the lateral line organ. Noises or vibrations in the water, which is not their natural experience, scare off fish and they are not attracted by it.

Furthermore, the self-moving bait fish is not or only very roughly controllable by the angler and therefore performs largely uncontrolled movements. This increases the risk of knots in particular in the line. For the control of artificial, self-propelled bait fish, it has already been proposed in DE 195 12 031 A1 to carry a data line from the angler to the artificial, self-propelled bait fish in addition to the fishing line. Such an arrangement is practically very difficult to handle in water and additionally carries the risk of knot formation. In addition, additional control equipment is required on the angler side and a special rewinder with initiation of control signals into the data line.

It is therefore an object of the present disclosure to provide a self-moving artificial bait fish which does not have the disadvantages of the state of the art and imitates a natural movement sequence of a healthy or sick prey for the predatory fish to be caught that can be controlled or adjusted in a defined manner by the angler, largely without emitting unnatural vibrations and thereby enabling the use of a conventional rod assembly. Furthermore, it is the task of the present disclosure to provide a method for controlling a self-moving artificial bait fish.

### SUMMARY

The present disclosure provides a self-movable artificial bait fish a method for controlling a self-movable artificial bait fish.

The self-moving artificial bait fish extends from a posterior extremity at the tail end in the direction of movement y over a total length L1 to an anterior extremity at the head end.

The self-moving artificial bait fish is the most lifelike reproduction possible of a fish to be reproduced as prey. It comprises a body with a body shell made of a waterproof material that surrounds the elements arranged inside. A body shell of the self-moving artificial bait fish advantageously comprises an elastic material such as plastic in particular elastomers, rubber or silicone, with a defined modulus of elasticity in the range between 0.5 MPa to 100 MPa, or a Shore hardness A in accordance with DIN ISO 7619-1 in the range of 5 to 90 Shore hardness A, preferably in the range of 10 to 60 Shore hardness A.

The lengths given in the sequence refer to a point 0, which is defined in the direction of movement y by the rear extremity at the tail end. If a part of the self-moving artificial bait fish should protrude backwards beyond the tail end, this forms the rear extremity. If a part of the self-moving artificial bait fish should protrude beyond the head end, this forms the front extremity.

The self-moving artificial bait fish has a shape centre of gravity in which the self-moving artificial bait fish immersed in water experiences a buoyancy force directed upwards towards the water surface by displacement of water volumes. The position of the shape centre of gravity can be changed over its position and/or volume by means of an artificial swim bladder arranged in the self-movable artificial bait fish, if the self-movable artificial bait fish is otherwise firmly shaped.

The self-moving artificial bait fish also has a centre of gravity in which the self-moving artificial bait fish immersed in water experiences a downwardly directed weight force caused by gravity towards the bottom of a water body. The position of the centre of gravity can be changed by changing the position of relatively heavy elements such as the energy source or optionally available ballast weights.

The self-moving artificial bait fish is designed with regard to the position of the shape centre of gravity and the centre of gravity in such a way that the shape centre of gravity of the self-moving artificial bait fish immersed in water is above the centre of gravity. This ensures a stable position of the self-moving artificial bait fish. The connecting cord leading through the shape centre of gravity and the center of gravity is hereinafter referred to as plumb or perpendicular axis.

A drive point is defined as the point at which during forward movement v, relative to the surrounding water in direction of movement y, caused by drive means, the force transmission Fyv from the surrounding water into the self-moving artificial bait fish with the sum of force components Fyi in direction of movement y takes place. The drive point of a self-moving artificial bait fish with tail-side drive means lies in the area of the largest dynamic water displacement generated by the tail fin in connection with a torso movement. The drive point is located, in particular in the case of an escape movement to be simulated, depending on the shape of the tail fin and the body shape of the self-movable artificial bait fish and on the state of movement of the drive means in the direction of movement y in the range from 0 times to 0.5 times the total length L1, preferably in the range from 0 times to 0.4 times the total length L1, in particular preferably in the range from 0.1 times to 0.3 times the total length L1, starting from the rear extremity at the tail end of the self-movable artificial bait fish.

In a preferred embodiment, an electromagnetic drive can be arranged as a drive within the self-moving artificial bait fish. The drive means comprise, for example, a tail fin, which can be set directly into oscillating motion via an electromagnetic drive oscillating transversely to the direction of motion y, whereby a force component Fyv directed forwards in the direction of motion y can be generated in the water, which causes a lifelike forward motion v relative to the surrounding water.

In another preferred embodiment, a piezo actuator can be provided as drive means at the tail end of the self-moving artificial bait fish to generate an oscillating tail movement, wherein a force component Fyv directed in the direction of movement y forwards can be generated in the water.

In another preferred embodiment, a rotating propeller or a screw may be provided as drive means at the tail end of the self-moving artificial bait fish, wherein, moved by a rotating drive such as an electric motor in the water, a force component Fyv directed in the direction of movement y forwards can be generated.

Alternatively, a self-moving artificial bait fish can be provided with head-mounted propulsion means, such as a head-mounted propeller, a screw or a jelly-like drive oscillating in the direction of motion y, which generates a force Fyv directed in the direction of motion y and a drive point located in the front part. The drive point of a self-moving artificial baitfish with head-side drive is in the range of 0.5 times to 1.0 times the total length L1, starting from the rear extremity at the tail end of the self-moving artificial baitfish, depending on the shape of the self-moving artificial baitfish and the state of motion of the drive means in the direction of motion y.

To securely attach the self-moving artificial bait fish to the connecting cord to the angler, at least one fastener such as an eye or a clamp or a swivel or carabiner is preferably attached to the self-moving artificial bait fish. Optionally, several fasteners can be provided at different positions to adapt the position of the fastener cord to the angler to different control situations. Optionally, at least one fastener can be adjustable and lockable on the self-moving artificial bait fish. The connection cord to the angler is attached to one of the fasteners using familiar connection techniques such as knots or line clamps. The connecting cord to the angler can include several components such as a leader, a main line and, if necessary, backing behind the main line. The connecting cord is preferably guided on the angler side from the tip of a fishing rod through the eyes of the fishing rod to a rewinder which can be operated by the angler.

At the fastening means for fastening the connecting cord to the angler, a force component Fyr caused by the connecting cord to the angler and directed against the direction of movement y acts during forward movement of the self-movable artificial bait fish and/or during retrieval of the self-movable artificial bait fish and/or during striking of the fishing rod. For stable control of the self-moving artificial bait fish, it is necessary that the position of a fastening means for fastening in the fixing point of the connecting cord to the angler in the direction of movement y is in the range from 0 times the total length L1 to a maximum of one position behind the position of the drive point. This ensures that a force component Fyv acting forwards in the direction of movement y is always applied in the direction of movement y in front of the backwards force component Fyr, which acts on the self-moving artificial bait fish via the fastening means for fastening the connecting cord to the angler. As a result, the self-moving artificial bait fish always remains directed away from the connecting cord to the angler and drags it behind it. In this way, a stable control of the self-movable artificial bait fish aligned in the direction of movement y is ensured in accordance with the invention. The angler can cast the self-moving artificial bait fish as usual or from the shore or from the boat into the water and head for a point in the water where he suspects the predatory fish to be caught.

The position of the fixing point for fixing the connection line to the angler on the self-moving artificial bait fish relative to the drive point and its difference vector dkrit directed from the drive point to the fixing point with an amount of more than 0 is therefore decisive for stable controllability of the self-moving artificial bait fish. The position of the attachment point for attaching the connection cord to the angler can be arranged in the direction of movement y in the area from the rear extremity at the tail end to a maximum of one position behind the position of the drive point. The arrangement of the fasteners in accordance with the invention is an essential component of the control means for controlling the self-moving artificial bait fish. An arrangement in which the drive point in the direction of movement would lie behind or in the position of the attachment of the connecting cord to the angler, for example by attaching the connecting cord to the angler at the head end or in the front third as is customary with artificial bait fish, would lead to a twisting and an undefined lateral breakout of the self-movable artificial bait fish and thus to an uncontrolled movement of the self-movable artificial bait fish due to the force components Fyv and Fyr acting against each other and due to the unstable relative position to each other in this case. A position of the attachment of the connecting cord to the angler in the direction of movement before or in the position of the drive point would lead to an unstable balance and thus to an uncertain controllability of the self-movable artificial bait fish.

Optionally, further control means can be provided for controlling the self-moving artificial bait fish. For example, adjustable and lockable elevators on the right and left and/or adjustable and lockable elevators on the bottom of the self-moving artificial bait fish can be provided for dynamic trimming of the direction of movement via control actuators and/or manually adjustable and lockable flow elements such as lower rudder and/or upper rudder and/or adjustable and lockable elevator. Control actuators preferably comprise converters for converting electrical energy into kinetic energy. For example, electromagnetic transducers and/or capacitive transducers and/or piezoelectric transducers can be used.

Alternatively or additionally, control actuators and/or manually adjustable and lockable means may be provided in the self-moving artificial bait fish for shifting the centre of gravity and/or the shape centre of gravity to statically trim the position of the self-moving artificial bait fish. In combination with a forward movement of the self-moving artificial bait fish, together with a fixed or adjustable flow body, for example an elevator, the self-moving artificial bait fish can be controlled to descend or emerge.

The direction of the self-moving artificial bait fish can be achieved by controlling the position of the shape centre of gravity. This can be achieved, for example, by changing the volume and position of the float and/or the centre of gravity, for example by shifting a mass body, such as the energy source or a ballast body, using a control actuator connected to an electronic control unit. The electronic control unit can advantageously control the control actuator based on programming or, if necessary, in response to a decoded message from the angler. The position of the artificial bait in the water can be changed and the forward movement generated by the drive and the water flowing past the flow element can generate a force component downwards or upwards or to the right or left, whereby the artificial bait is deflected to the right or left and/or dives deeper and/or is deflected upwards in the direction of the water surface.

Optionally, a pressure sensor for detecting the static water pressure can be arranged on the electronic control unit, prevailing at the current diving depth, whereby in connection with the electronic control unit the means for controlling the diving depth via the water pressure are controlled in such a way that a certain diving depth can be maintained due to the programming, if necessary in reaction to a decoded message from the angler.

Optionally, the electronic control unit can be equipped with means for the release of acoustic attractants and/or optical attractants and/or flavouring attractants for attracting prey fish. These lures can optionally be activated and deactivated by the control unit. Acoustic attractant dispensers may include an electromechanical vibrator that emits vibrations, in particular a diseased bait fish, to the surrounding water in a simulating manner. For example, means for emitting optical attractants may include a flashing light-emitting diode and/or a continuous signal emitting light-emitting diode which emits attracting optical signals to the surrounding water. Means for the release of flavouring lures may comprise a manually fillable lure tank in the self-moving artificial bait fish, which can be emptied or permanently emptied by control signal, simulating a flavouring lure substance, for example body fluid of a sick or dead bait, or releases an aromatic substance into the surrounding water.

Means may be advantageously provided which, in the case of a tail-side drive with a magnetically moved oscillating tail fin, can control the deflection of the tail fin or, in the case of a head-side drive with a magnetically moved oscillating jelly-like head end with regard to frequency and/or amplitude and/or switch it off or on temporarily. The frequency determines the number of deflections per unit of time of the tail fin or the extension and contraction of the jellyfish-like head end. This allows the speed of the forward movement on the one hand and the type of movement on the other hand to be determined. In the case of a tail-side drive with magnetically moved oscillating tail fin, the amplitude of the tail fin deflections can be determined or in the case of a head-side drive with magnetically moved oscillating jelly-like head end, the amplitude of the jelly-like head end can be determined as the strength of the forward force Fyv. For example, a distinction can be made between the control of a normal swimming movement and an escape-like swimming movement.

In a preferred embodiment, the periodic electrical control of the drive excitation can take place with an asymmetrical curve and the tail fin of the tail-side drive can be set into asymmetrical oscillating motion.

The advantage of a tail-side drive with a magnetically moving oscillating tail fin is that the periodic electrical control of the drive excitation can be optionally provided with an asymmetrical time curve. As a result, the amplitude deflections over time, i.e. the integral of the generated force and thus the work performed, are shifted in positive and negative directions with respect to a neutral central position of the tail fin, or the directional time-dependent position of the tail fin and thus directional control is achieved via an asymmetrical oscillating movement of the tail fin. Depending on the vertical or horizontal orientation of the tail fin in neutral position, the self-moving artificial bait fish can be controlled to the left or right or up or down.

For the control of the self-moving artificial bait fish, message detection means may preferably be provided in the self-moving artificial bait fish, which convert defined changes in the force action Fyr of the connecting cord from the self-moving artificial bait fish to the angler or in the speed v or a sluggish negative acceleration of the self-moving artificial bait fish, in particular short jerky changes or long drawn changes, into electrical signals which are decoded by an electronic control unit and converted into electrical control commands for controlling the control actuators. For example, message capture devices may include an acceleration sensor, such as an integrated MEMS sensor or a cord sensor. The cord sensor comprises either a switch with a force-specifically defined switching point or a sensor for the analog conversion of force into an electrical value, such as a piezo element, a strain gauge, an optoelectronic sensor, an inductive sensor or a capacitive sensor or a pressure sensor.

In this way the angler can generate different mechanical signals or temporally defined impulses, which are mechanically transmitted via the connecting cord to the self-moving artificial bait fish and are received as signals by the message detection device by means of temporally defined and/or jerky changes, for example by jerky withdrawal or by partially striking the tip of the fishing rod. In this way, the angler can advantageously send out one or more coded control messages to control the self-moving artificial bait fish by means of individual signals or by a time sequence of signals. The signals can also differ in length in order to send individual characters and/or whole words to the self-moving artificial bait fish for controlling the control actuators and/or the drive, comparable to the morse alphabet. Optionally, at least one start character and/or at least one stop character is agreed, whereby an intermediate sequence of characters with or without start or stop characters is interpreted as a message. Additionally, or alternatively, a time window can be agreed from the first character within which a sequence of characters is interpreted as a message.

The electronic control unit comprises an electronic circuit, advantageously a programmable microcontroller with program memory, data memory and corresponding drivers for controlling the control actuators and/or the drive. The electronic control unit advantageously includes a decoder for decoding the electrical signals converted by a message acquisition device. The semantic assignment or meaning of the coding of messages can be advantageously fixed in the decoder or optionally programmed by the angler via an interface to the electronic control unit.

The interface may be a wired interface such as a USB interface or RS232 interface on the self-moving artificial baitfish with sealable contacts, or may be a wireless interface in the self-moving artificial baitfish such as a Bluetooth interface or WiFi interface. For programming the electronic control unit, a computer such as, for example, a stationary or portable computer, a tablet or smartphone or other means of telecommunication may be used on the angler's part. Advantageously, this computer has a further interface to a remote computer or an internet in order to be able to download ready-made programmes or updates for programming the electronic control unit of the self-moving artificial baitfish from there.

The energy source for supplying the electronic control unit of the control actuators and the drive can be a battery or rechargeable energy sources such as an accumulator or a capacitor, for example a so-called “supercap”. In the case of a rechargeable energy source, charging can be performed via an external electrical energy source such as the cigarette lighter from a car battery or an external accumulator such as a “power pack” and via the wired interface.

Alternatively, a wireless charging process comparable to an electric toothbrush is possible, in which the electrical energy is transmitted inductively or capacitively to a receiving unit in the self-moving artificial bait fish and from there to its rechargeable energy source.

To provide optional waterproof access to replace a battery or to access a wired interface, the self-moving artificial bait fish has a screw cap with seal or an elastic closure such as a closure plug, which can be removed and re-closed to allow access to the battery and/or the wired interface and re-sealed in a watertight manner.

The control means shall also include a sealed switching device operable from outside the self-moving artificial bait fish for establishing and breaking an electrical connection between the electrical energy source and the electrical loads such as the drive, the electronic control unit, the drive driver for controlling the drive and the optional sensors and control actuators within the self-moving artificial bait fish. Optionally, other manually operable control actuators, such as switches or potentiometers, can be provided for adjusting the frequency and/or the amplitude and/or the duty cycle or a symmetrical or asymmetrical timing of the drive and/or desired control program version and/or for shifting the shape centre of gravity and/or the centre of gravity and/or of flow bodies such as one or more elevators and/or rudders. Manually operated controls are set by the angler according to a desired control option before the self-moving artificial bait fish is launched.

As a tail-side drive, an electromagnet can preferably be arranged as a drive excitation with periodic electrically unipolar control or with bipolar control by a drive driver, controlled by signals from the electronic control unit. The periodic electric control generates a periodic electric current flow in the coil of the electromagnet, which generates a periodic magnetic field that can be controlled with a defined north-south polarization when driven unipolarly and with alternating north-south polarization and intensity when driven bipolarly.

An air gap between the pole shoes of a ferromagnetic core or, if no core is used, between the pole ends of the electromagnet and the end of a lever, optionally with a spring which is connected to the tail fin via a pivot point, a magnetic drive receiving element, preferably a permanent magnet drive receiving element, on which an alternating force effect is exerted by the magnetic field generated by the electromagnet. In another embodiment, the drive medium is immersed contact-free into the interior of an electromagnetically excited coil.

Advantageously, the material of the elastic body shell and the transition area of the tail fin itself encloses the lever, so that in this case no own lever is required. Furthermore, the propulsion-receiving agent can be located inside the body shell, the transitional area of the tail fin or in the tail fin itself.

In the case of a separate lever, this preferably comprises a resilient material or a restoring material having a higher modulus of elasticity or a harder spring constant than that of the selected material of the tail fin and/or the material of the surrounding shell of the self-moving artificial bait fish, whereby the tail fin performs a tracking elastic force transmission from the drive to the surrounding water.

The lever thus is set into direct, oscillating motion cross to direction of movement y and thus over fulcrum the tail fin. This creates a direct natural movement of the self-moving artificial bait fish without unnatural mechanical vibrations due to rotation, commutation, mounting of a drive motor or a gear, or eccentric mechanics or the like. The drive is largely silent and emits the same vibrations when the tail fin moves in the water as a living fish in its natural movement situations from standing in the water to fleeing movement or movements in the injured or sick state.

In a preferred embodiment, instead of an electromagnetic drive, a piezo element can also be arranged in the tail fin, which is controlled by the control voltage from the drive driver, controlled by periodic signals from the control device unipolar or bipolar, and thus generates a direct, oscillating tail movement transversely to the direction of movement y.

The drive is compact and cost-effective and can be easily controlled by changing the electrical control voltage and thus the electrical excitation current flowing through the coil of the electromagnet or the electrical control voltage at the piezo element in its waveform, its frequency, its amplitude and its duty cycle or a time-balanced or asymmetrical waveform.

An electromagnet with periodic control, electrically unipolar control or with electrically bipolar control by a drive driver, controlled by signals from the electronic control unit, can optionally be arranged as a head-side drive. The periodic electric control generates a periodic electric current flow in the coil of the electromagnet, which generates a periodic magnetic field that can be controlled with a defined north-south polarization for unipolar control and with alternating north-south polarization for bipolar control.

A magnetic, preferably a permanent magnet drive receiving means is arranged in the head part of the self-moving artificial bait fish via an air gap from the pole shoes or—if no core is used—from the pole ends of the electromagnet. Preferably, the drive medium in a further embodiment form dips contactlessly into the interior of an electromagnetically excited coil.

The head part, for example, consists of a jelly-like elastic drive cap which, when stretched, rests against the body of the self-moving artificial bait fish and, when compressed, opens outwards to a defined extent. The magnetic field generated by the electromagnet in the direction of movement y exerts an alternating force on the head part of the drive receiving means. This causes the head part to oscillate directly and generates a force component Fyv directed in the direction of movement y when opening and closing. This creates a natural movement of the self-moving artificial bait fish without additional unnatural mechanical vibrations due to commutation or eccentric movement. The drive is largely silent and emits the same vibrations when the headboard moves in the water as a living fish, which moves forward in jerks without unnatural mechanical vibrations due to rotation, commutation, bearings or eccentric mechanics or the like.

In another preferred embodiment, instead of an electromagnetic drive, a piezo element can also be arranged in the elastic drive cap of the head-side drive, which is controlled with the control voltage from the drive driver by periodic signals of the control device, unipolar or bipolar, and thus generates a direct, oscillating movement of the elastic drive cap in the direction of movement y.

The drive is compact and cost-effective and can be controlled directly in a simple way by changing the electrical control voltage and thus the electrical control current flowing through the coil of the electromagnet or the electrical control voltage at the piezo element in its waveform, its frequency, its amplitude and its duty cycle or a time-balanced or asymmetrical waveform.

Advantageously, at least one means of locating is optionally provided in the self-movable artificial baitfish. In particular, GPS locating means or acoustic locating means, for example ultrasonic transmitters, are provided as locating means. Locating means are preferably used for the retrieval of a possibly lost self-movable artificial bait fish.

The following method steps can be used to control the self-moving artificial bait fish:
provision of an ingenious self-moving artificial bait fish
attachment of a connecting cord to the angler on a fastener of the artificial bait fish,
deploying the artificial bait fish in a surrounding water or body of water, wherein the self-moving artificial bait fish drags the connecting cord to the angler behind its drive point due to the position of the attachment point in the direction of movement y.

For the control of the self-movable artificial bait fish, the following optional method steps can be applied:
providing a self-moving artificial bait fish with a decoder,
providing a message detection means, in particular a sensor, for detecting tension variations between the self-moving artificial bait fish and connecting cord to the angler and/or speed variations of the self-moving artificial bait fish,
coding a message by causing line pull variations to the angler by the angler and/or speed variations of the self-moving artificial bait fish by causing line pull variations to the angler by the angler,
decoding of the coded message by the decoder in the self-moving artificial bait fish
performing a control action in response to the decoded message by at least one control actuator and/or driving the self-moving artificial bait fish.

The order of the method steps is not mandatory as shown. Individual method steps can be brought forward or postponed without changing the effectiveness of the proposed method examples.

### BRIEF DESCRIPTION OF THE DRAWINGS

These and other features of the present invention result from the following description of preferred forms of execution of the present invention, which do not represent restrictive examples, whereby reference is made to the following figures.

FIG. 1 shows exemplary forces on the self-moving artificial lure fish with tail-side drive,

FIG. 2 shows exemplary forces in the self-moving artificial bait fish with jellyfish-like drive at the head,

FIG. 3 shows the cutting plane C-D of a self-moving artificial bait fish with tail-side propulsion and vertically oriented tail fin in side view,

FIG. 4 shows the cutting plane A-B of a self-moving artificial bait fish with tail-side drive and vertically oriented tail fin in plan view,

FIG. 5 shows an arrangement of control means and drive means in the self-moving artificial bait fish with tail-side drive and vertically oriented tail fin in the representation of the cutting plane C-D of a side view,

FIG. 6 shows a principle arrangement of drive means in the self-moving artificial bait fish with tail-side drive and vertically oriented tail fin in the representation of the cutting plane A-B of a plan view,

FIG. 7 shows the cutting plane C-D of a self-moving artificial bait fish with tail-side propulsion and horizontally oriented tail fin in side view,

FIG. 8 shows the cutting plane A-B of a self-moving artificial bait fish with tail-side drive and horizontally oriented tail fin in plan view,

FIG. 9 shows the cutting plane A-B of a self-moving artificial bait fish with top view drive,

FIG. 10 shows drive means of a tail-side magnetic drive with arrangement of the drive receiving means within the body of the self-moving artificial bait fish with bipolar excitation,

FIG. 11 shows drive means of a tail-side magnetic drive with arrangement of the drive receiving means within the transition area or the tail fin of the self-moving artificial bait fish with bipolar excitation,

FIG. 12 shows drive means of a tail-side piezoelectric actuator with bipolar excitation,

FIG. 13 shows drive means of a tail-side magnetic drive with arrangement of the drive receiving means within the body of the self-moving artificial bait fish with unipolar excitation,

FIG. 14 shows drive means of a tail-side magnetic drive with arrangement of the drive receiving means within the tail fin of the self-moving artificial bait fish with unipolar excitation,

FIG. 15 shows drive means of a tail-side piezoelectric actuator with unipolar excitation,

FIG. 16 shows a bipolar signal curve of a periodic control voltage uA(t) or a periodic excitation current iA(t) with symmetrical straight-line movement of a tail-side drive,

FIG. 16b shows a bipolar signal curve of a periodic control voltage uA(t) or a periodic excitation current iA(t) with asymmetrical movement of a tail-side drive with direction control on the left,

FIG. 16c shows a bipolar signal curve of a periodic control voltage uA(t) or a periodic excitation current iA(t) with asymmetrical movement of a tail-side drive with direction control on the right,

FIG. 17a shows a unipolar signal curve of a periodic control voltage uA(t) or a periodic excitation current iA(t) with symmetrical straight-line movement of a tail-side drive,

FIG. 17b shows a unipolar signal curve of a periodic control voltage uA(t) or a periodic excitation current iA(t) with asymmetrical movement of a tail-side drive with direction control on the left,

FIG. 17c shows a unipolar signal curve of a periodic control voltage uA(t) or a periodic excitation current iA(t) with asymmetrical movement of a tail-side drive with direction control on the right,

FIG. 18 shows a self-moving artificial bait fish with magnetic drive on the head side in jellyfishlike stretched out condition,

FIG. 19 shows a self-moving artificial bait fish with magnetic drive on the head side in a jelly-like contracted state,

FIG. 20 shows the situation of an angler with a fishing rod and a self-moving artificial bait fish introduced into a body of water.

### DETAILED DESCRIPTION

In the following, preferred embodiments of the present invention are explained in more detail using the accompanying figures.

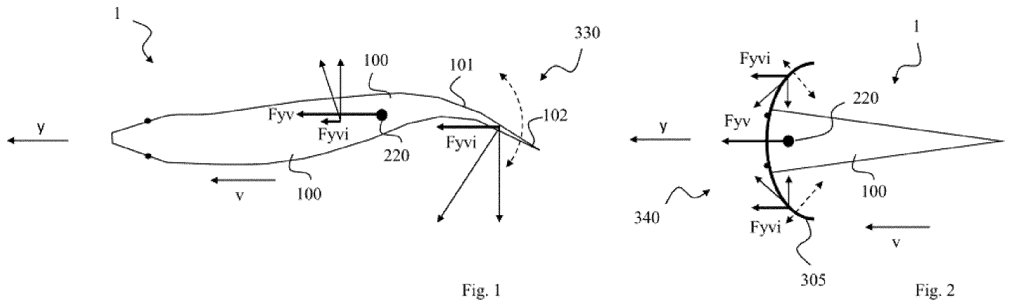

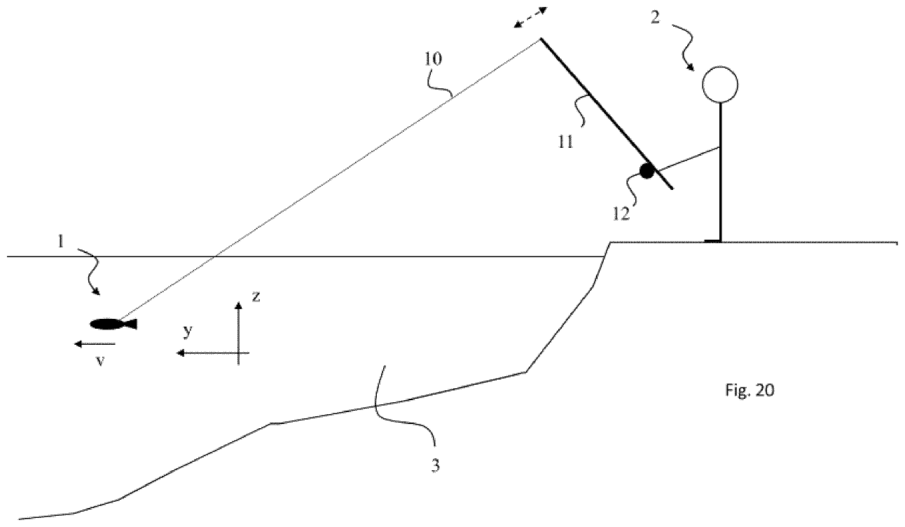

FIG. 1 shows exemplary forces and their components in a self-moving artificial bait fish 1 with a tail-side drive 330. Due to the oscillating movement of a tail fin 102 transversely to the direction of movement y and a transition area of the tail fin 101 with respect to the remainder of a body shell 100 of the self-movable artificial bait fish 1 force components are generated in different directions with respect to a surrounding water 3 (see FIG. 20). Of the force components, the force components Fyvi directed forwards in the direction of motion y are particularly relevant according to the invention. The force components Fyvi effectively add up at a drive point 220 into the resulting force component Fyv directed in the direction of motion y. The self-moving artificial bait fish 1 therefore moves at a speed v relative to the surrounding water 3 (not shown in FIG. 1).

FIG. 2 shows exemplary forces and their components in the self-moving artificial bait fish 1 with a head side drive 340. Due to the oscillating movement in the direction of movement y of a jelly-like elastic drive cap 305 of the head side drive 340, force components are generated in different directions in relation to a surrounding water 3 (see FIG. 20). Of the force components, the force components Fyvi directed forwards in the direction of motion y are particularly relevant according to the invention. The force components Fyvi effectively add up at a drive point 220 into the resulting force component Fyv directed in the direction of motion y. The self-moving artificial bait fish 1 therefore moves at a speed v relative to the surrounding water 3 (not shown in FIG. 2).

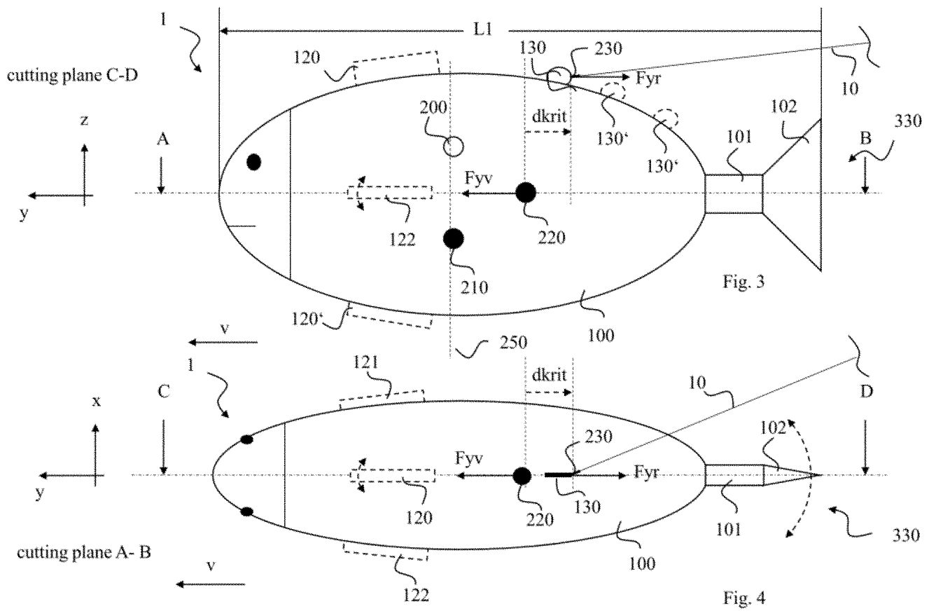

FIG. 3 shows an embodiment of a self-moving artificial bait fish 1 with a tail-side drive 330 and a vertically oriented tail fin 102 in the cutting plane C-D of the side view. The length L1 relevant for the proportions of the invention extends from the rear extremity 5 at the tail end of the tail fin 102 of the self-moving artificial bait fish 1 to the front extremity 6 at the head end of a body shell 100 of the self-moving artificial bait fish 1. A connecting cord 10 to an angler 2 (see FIG. 20) is attached to a fastener 130 at a fixing point 230. At this point, a force component Fyr, directed against the direction of movement y, intervenes, which is caused by the backwards force of the connecting cord 10 to angler 2, which is caused on the one hand by friction of the connecting cord 10 to angler 2 on the surrounding water 3 (see FIG. 20) and on the other hand by backwards force of the rod assembly.

Starting from a drive point 220, the vector dkrit is directed, which indicates the distance between the drive point 220 and the fixing point 230 as an amount and the distance to the fixing point 230 as a direction starting from the drive point 220 against the direction of movement y.

For stable control of the self-moving artificial bait fish 1 it is necessary that the position of the fixing point 230 of the connecting cord 10 to angler 2 in direction of movement y, starting from the rear extremity, lies in the range of 0 times the total length L1 up to a maximum of one position behind the drive point 220. This ensures that a force component Fyv acting forwards in the direction of movement y is always applied in front of the backward force component Fyr in the direction of movement y, which acts on the self-moving artificial bait fish 1 via the fasteners 130 at fixing point 230 for fastening the connecting cord 10 to angler 2. As a result, the self-moving artificial bait fish 1 always remains directed away from the connecting cord 10 to the angler 2 in the direction of movement y and drags it behind it. In this way, a stable control of the self-moving artificial bait fish 1 aligned in the direction of movement y is ensured in accordance with the invention. Angler 2 can cast the self-moving artificial bait fish 1 as usual or from the shore or from the boat into the surrounding water 3 and head for a point in the water or water where he suspects the predatory fish to be caught. The angler 2 and the surrounding water is shown, for example, in FIG. 20.

Optionally, several fasteners 130, 130′ can be provided at different positions to adapt the position of the fixing point 230 of connecting cord 10 to angler 2 to different control situations. Optionally, at least one adjustable and lockable fastener 130, 130′ can be arranged on the self-moving artificial bait fish 1.

The self-moving artificial bait fish 1 has a shape centre of gravity 200, in which the self-moving artificial bait fish 1 immersed in surrounding water 3 experiences a buoyancy force directed upwards towards the water surface by displacement of water volume. The position of the shape centre of gravity 200 can be changed over its position and/or volume by an artificial swim bladder 440 (compare FIG. 6) arranged in the self-movable artificial bait fish if the shape of the self-movable artificial bait fish is essentially fixed.

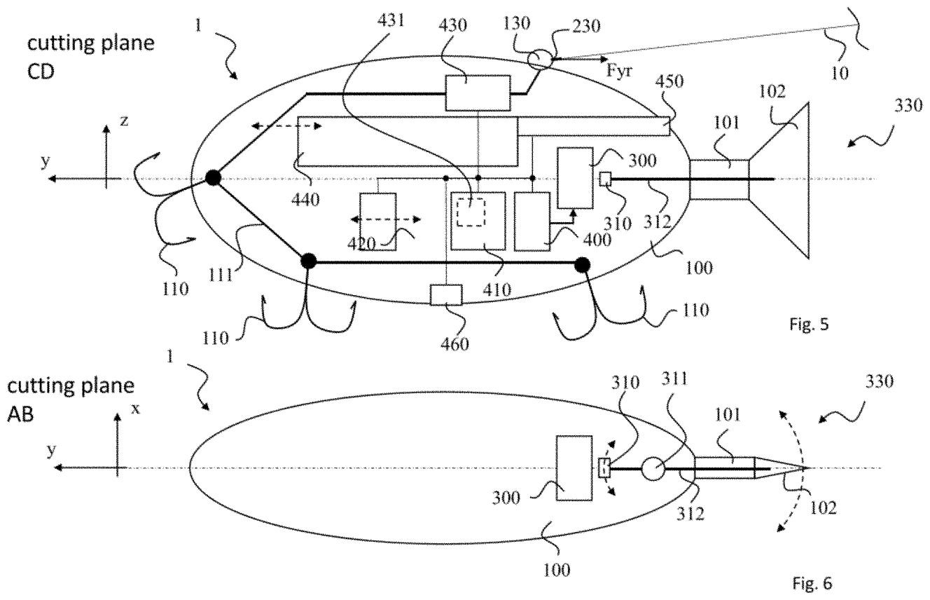

The self-moving artificial bait fish 1 also has a centre of gravity of 210 in which the self-moving artificial bait fish 1 immersed in surrounding water 3 experiences a gravity-induced downward force towards the bottom of the water body. The position of the centre of gravity 210 can be changed by changing the position of relatively heavy elements of the self-moving artificial bait fish 1 such as the energy source 420 (see FIG. 5) or of optional ballast weights (not shown).

With regard to the position of the shape centre of gravity 200 and the centre of gravity 210, the self-moving artificial bait fish 1 is designed such that the shape centre of gravity 200 is above the centre of gravity 210 for the self-moving artificial bait fish 1 immersed in surrounding water 3. This ensures a stable position of the self-moving artificial bait fish 1. The connecting cord leading through the shape center of gravity 200 and through the center of gravity 210 is hereinafter referred to as the plumb axis 250. With static trimming of the self-moving artificial bait fish 1, the plumb axis 250 points in the direction of the earth's centre of gravity, i.e. towards the bottom of the water in which the self-moving artificial bait fish 1 floats.

For dynamic control with existing relative speed v between the self-moving artificial bait fish 1 and the surrounding water 3, flow bodies such as the optionally shown elevators 122 and 121 (see FIG. 4) and/or optionally a rudder 120 above and/or optionally a rudder 120′ (not shown) can be arranged at the bottom of the body shell 100 of the self-moving artificial bait fish 1 as control means. The control means 120, 120′, 121, 122 are, if available, fixed or either manually adjustable, for example via manually operated control actuators 450 (see FIG. 5) and/or via electrical control actuators (not shown) of the self-moving artificial bait fish 1.

In this embodiment, the tail fin 102 is vertically aligned. The oscillating movement takes place transversely to the direction of movement y in positive and negative directions of the horizontal x-axis (see, for example, FIG. 4).

FIG. 4 shows the cutting plane A-B of the embodiment of a self-moving artificial bait fish 1 from FIG. 3 with tail-side drive 330 and vertically oriented tail fin 102 in plan view.

FIG. 5 shows an example of an arrangement of control means and drive means in the self-moving artificial bait fish 1 with tail-side drive 330 and vertically oriented tail fin 102 in the representation of the cutting plane C-D of a side view.

The drive elements 300, 310, 312, 101 and 102 are shown. A drive excitation 300, which exerts an electromagnetic force on a drive receiving means 310, generates an oscillating motion transverse to the direction of motion y, which is transmitted to a tail fin 102 via a drive lever 312 and a transition area 101 of the tail fin. A torque can be generated advantageously via a drive bearing point 311 (see FIG. 6) and the drive force is over or reduced.

The drive receiving means 310 comprises a magnetic material without defined magnetic polarization or preferably a permanent magnetic material with defined magnetic polarization.

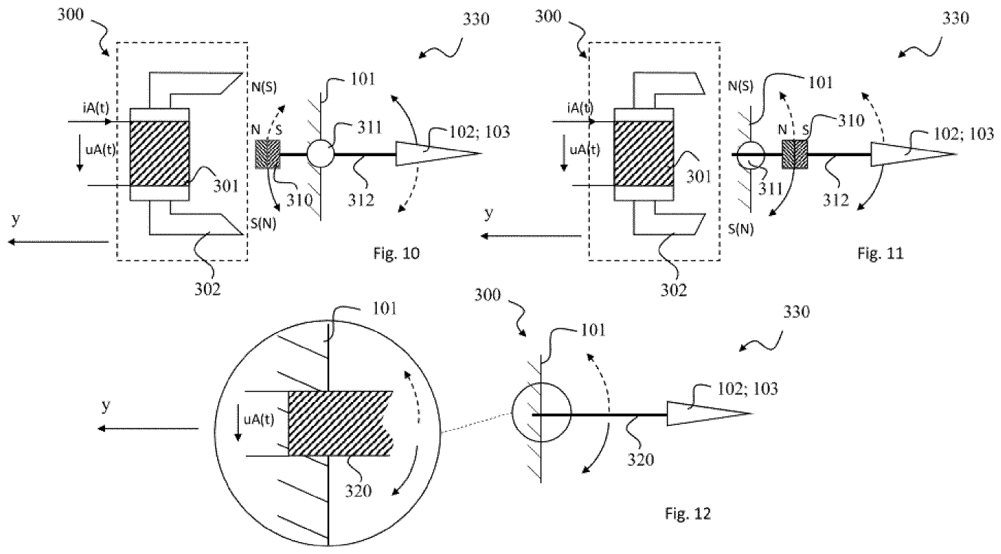

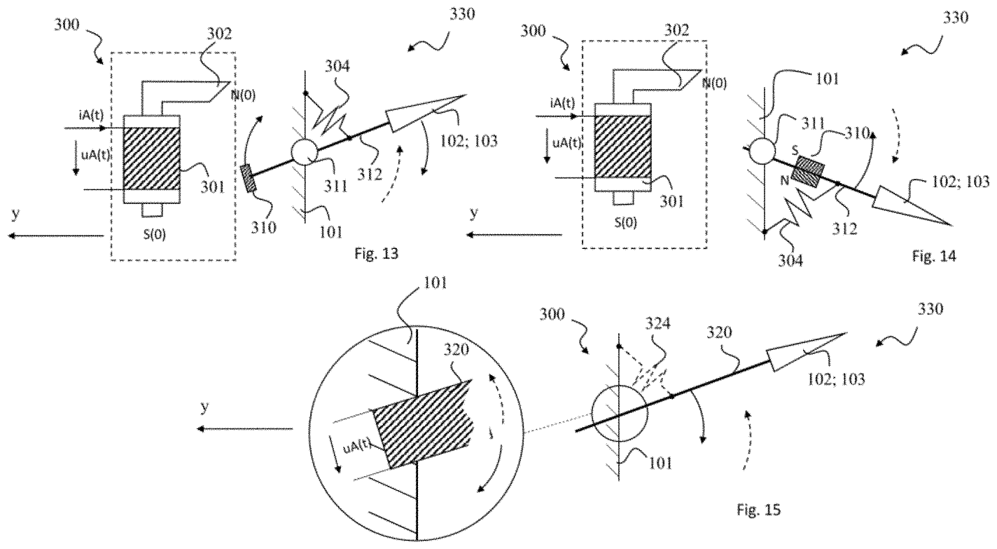

The drive excitation 300 comprises a coil 301 (see FIG. 10, FIG. 11, FIG. 13 and FIG. 14) of n windings with or without a core of magnetic material 302. When excited by a control voltage uA(t) (see FIG. 10, FIG. 11, FIG. 13 and FIG. 14), an electric control current iA(t) flows through the coils of coil 301 and generates an escaping magnetic field with defined polarity N, S at the ends of coil 301 or at the poles or pole shoes of the magnetic core 302. The position of polarity N, S is determined by the direction in which the control current iA(t) flows through the coils 301 and the strength of the magnetic field is determined by the amount of the control current iA(t) and the number of coils n of the coil 301.

For bipolar excitation (see FIG. 10 and FIG. 11) the drive receiving means 310 preferably comprises a permanent magnetic material with a defined magnetic polarization N, S, for unipolar excitation (see FIG. 13 and FIG. 14) the drive receiving means 310 comprises a magnetic material without a defined magnetic polarization or a permanent magnetic material with a defined magnetic polarization N, S.

A drive driver 400 is provided for controlling the drive means via the drive excitation 300, which provides the conversion of control signals of an electronic control unit 410 into the signal required for the drive excitation 300 with a defined time-dependent curve of the electrical control voltage uA(t) or the electrical control current iA(t). The control signal from the electronic control unit 410 is provided either as a digital signal or as an analog signal to the drive driver 400. The drive driver 400 converts this signal into a unipolar control voltage uA(t) or a bipolar control voltage uA(t) or into a unipolar control current iA(t) or into a bipolar electric control current iA(t). An energy source 420 supplies either a unipolar supply voltage or a split, i.e. bipolar supply voltage, which is oriented positively and negatively with respect to an electrical potential point between the total voltage. In the case of a unipolar supply voltage and bipolar excitation (see FIG. 10 and FIG. 11), the drive driver 400 comprises means such as a bridge circuit for changing the polarity of the control voltage uA(t) and the control current iA(t).

A cord sensor 430 and/or an acceleration sensor 431 can be provided as an optional message detection means. A message detection means detects the optionally provided changes in the backward force component Fyr at the fixing point 230 or of backward speed changes dv/dt as negative acceleration values of the self-moving artificial bait fish 1, converts these into an electrical signal and supplies this to the electronic control unit 410 for further evaluation of the time sequence of signals and, if necessary, for decoding.

For example, message detection means may include an acceleration sensor 431, such as an integrated MEMS sensor and/or a cord sensor 430.

In the case of an acceleration sensor 431, detection takes place via a spring-mass acceleration sensor in the self-moving artificial baitfish 1. Such inertial sensors evaluate the inertial force acting on a mass and can be very well realized on a silicon basis with so-called MEMS structures within an integrated electronic component in a compact and cost-effective manner. When a defined threshold value of the acceleration dv/dt detected in this way is exceeded, a signal is detected which is provided to the decoder for decoding.

The cord sensor 430 comprises either a switch with a force-specifically defined switching point, which at a defined mechanical force difference Fyv−Fyr between two mechanical connection points changes its electrical switching contact in a defined manner and thereby generates an electrical signal at a defined mechanical force difference Fyv−Fyr or a sensor for analog conversion of the force difference Fyv−Fyr into an electrical value, such as the result signal of a piezo element, a strain gauge, an optoelectronic sensor, an inductive sensor, a capacitive sensor or a pressure sensor.

The electrical power supply of the drive means and the control means is provided by a unipolar energy source 420 or by a split, bipolar energy source 420. The energy source 420 for supplying the electronic control unit 410 of the control actuators, the drive driver 400 and the drive excitation 300 may be battery cells or rechargeable energy sources such as accumulators or capacitors, for example so-called “supercaps”. In the case of a rechargeable energy source 420, charging can be performed via an external electrical power source such as the cigarette lighter of a car battery or an external accumulator/power pack and via the wired interface 460.

To shift the centre of gravity 210, the position of the mass of the energy source 420 and/or the mass of a ballast body (not shown) can optionally be changed via electrical control actuators (not shown) and/or manually via a sealed manual control means, such as a manually operated control actuator 450, which can be operated from the outside and extends inwards into the body shell 100, within the body shell 100 of the self-moving artificial bait fish 1. For example, a manually operated control actuator 450 includes mechanical setting means such as a screw, a clamp, a slide, a valve or the like or electrical setting means such as a potentiometer, a switch, an electrical or magnetically activatable contact/measuring point or the like.

Interface 460 may be a wired interface such as a USB interface or an RS232 interface or any other proprietary interface on the self-moving artificial bait fish 1 with sealable contacts or a wireless interface in the self-moving artificial bait fish 1, such as a Bluetooth interface or a WiFi interface. An Angler 2 can use a computer such as a stationary computer, portable computer, tablet or smartphone to program the electronic control unit 410. Advantageously, this computer has an additional interface to a remote computer or the Internet to download programs or updates for programming the electronic control unit 410 of the self-moving artificial bait fish 1.

The self-moving artificial bait fish 1 comprises at least one catch hook 110 to hook it to the self-moving artificial bait fish 1 in the event of a successful bite of a predatory fish to be caught. It is advantageous that the catch hook 110 is resiliently connected to the fastening device 130 via a catch hook reinforcement 111 in order to ensure a secure mechanical connection between the predatory fish to be caught and angler 2 via the connecting cord 10 to angler 2 and to be able to catch the catch by angler 2 even in the event of a heavy drill.

An optionally arranged artificial swim bladder 440 is used for the defined positioning of the shape centre of gravity 200 in a body shell 100 of the self-moving artificial bait fish 1 To shift the shape centre of gravity 200, the volume of the artificial swim bladder 440 and/or the position of the shape centre of gravity 200 within the body shell 100 can optionally be changed via electric control actuators (not shown) or manually via a manually operated control actuator 450. By shifting the shape centre of gravity 200 relative to the centre of gravity 210, the position of the plumb axis 250 changes relative to the direction of movement y and thus the static position (trim) or the angle of the plumb axis of the self-moving artificial bait fish 1, for example relative to the vertical direction z in the surrounding water 3. Together with a dynamic movement v of the self-moving artificial bait fish 1 relative to the surrounding water 3, together with one or more flow bodies, for example one or more elevators 121, 122 (see FIG. 3 and FIG. 4), it can be determined in which vertical z-direction the self-moving artificial bait fish 1 floats.

Optionally, a pressure sensor (not shown) for detecting the static water pressure of the current diving depth can be arranged on the electronic control unit 410, whereby in conjunction with the electronic control unit 410 the means for controlling the diving depth can be controlled in such a way that a certain diving depth is maintained, which is predetermined due to programming or in response to a decoded message from the angler.

Optionally, means (not shown) can be provided on the electronic control unit 410 for the release of acoustic attractants and/or optical attractants and/or flavouring attractants for attracting prey fish, which can optionally be activated and deactivated by the electronic control unit 410. Acoustic attractant dispenser means may include an electromechanical vibrator that emits vibrations, in particular a diseased bait fish, to the surrounding water in a simulating manner. For example, means for emitting optical attractants may include a flashing light-emitting diode or a continuous signal emitting light-emitting diode which emits attracting optical signals to the surrounding water. Flavouring lure dispensers means may include a manually fillable lure tank which can be emptied by a control signal or a permanently emptied lure tank in the self-moving artificial bait fish, which simulates a flavouring lure substance, for example a body fluid of a sick or dead bait, or releases an aromatic substance to the surrounding water.

Advantageously, at least one locating means (not shown) is optionally provided in the self-movable artificial baitfish 1. In particular, GPS locating means or acoustic locating means, for example ultrasonic transmitters, are provided as locating means. Locating means preferably serve to retrieve a possibly lost self-movable artificial bait fish.

FIG. 6 shows a basic arrangement of drive means in the self-moving artificial bait fish 1 with tail-side drive 330 and vertically oriented tail fin 102 in the representation of the cutting plane A-B of a plan view. The drive excitation 300 within the body shell 100 causes an oscillating movement of the drive receiving means 310 in the horizontal x-direction transverse to the direction of movement y due to an electromagnetic force effect. In this embodiment, the movement is transmitted via the drive lever 312 and the drive bearing point 311 to the transition area of the tail fin 101 and the tail fin 102. The drive lever 312, the transition area of the tail fin 101 and the tail fin 102 are thus set directly into oscillating motion transversely to the direction of motion y. Therefore, a natural movement of the self-moving artificial bait fish 1 occurs without unnatural mechanical vibrations due to contact, rotation, commutation, mounting of a drive motor or a gear, or an eccentric mechanism or the like. The drive is largely silent and emits the same vibrations during the movement of the tail fin 102 in the surrounding water 3 as a living fish in its natural movement situations from standing in the water 3 to the escape movement or during movements in the injured or sick state.

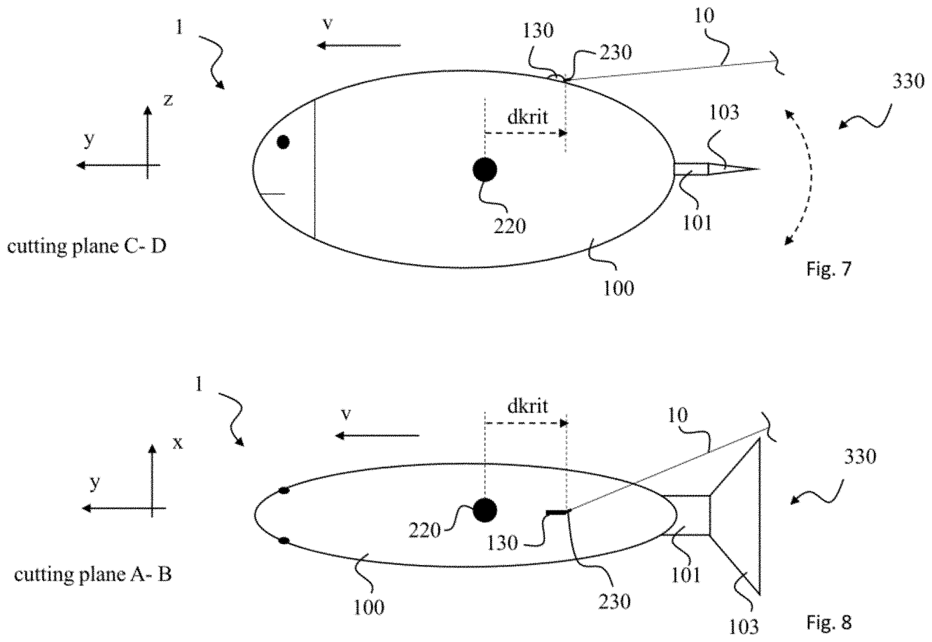

FIG. 7 and FIG. 8 show a self-moving artificial bait fish 1 with tail-side drive 330. The tail fin 103 in this embodiment is oriented horizontally in x-direction. The oscillating movement of the tail fin 103 in this embodiment takes place in vertical z-direction transversely to the direction of movement y, thus as with a dolphin or whale from top to bottom. Also, with this type of drive, the fixing point 230 must be located behind the drive point 220 in the direction of movement y in order to ensure a defined control.

The drive point 220 is located, in particular in the case of an escape movement to be simulated, depending on the shape of the tail fin 102, 103 and the body shape of the self-movable artificial baitfish 1 and on the state of movement of the drive means in the direction of movement y in the range from 0 times to 0.5 times the total length L1, preferably in the range from 0 times to 0.4 times the total length L1, in particular preferably in the range from 0.1 times to 0.3 times the total length L1, starting from the rear extremity at the tail end of the self-movable artificial bait fish 1.

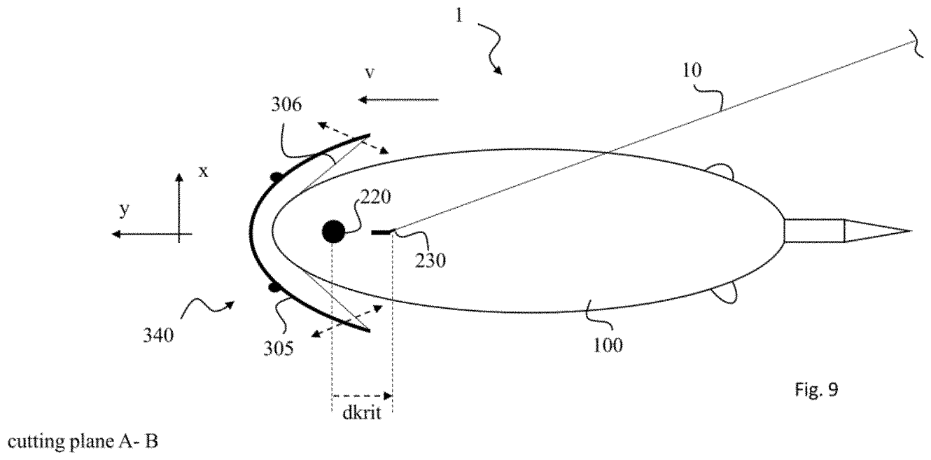

FIG. 9 shows the cutting plane A-B of a self-moving artificial bait fish 1 with drive 340 on the head side in plan view. Drive in direction of motion y is achieved by oscillating movement of a jelly-like head part in direction of motion y. Due to the head-side drive, the drive point 220 is close to the head end of the self-moving artificial bait fish 1. With this type of drive, too, the fixing point 230 must be arranged behind the drive point 220 in the direction of movement y, in order to ensure a defined control.

A self-moving artificial bait fish 1 with drive means attached to the head, for example, comprises a propeller attached to the head, a screw or a jelly-like drive oscillating in the direction of movement y, which generates a force Fyv directed in the direction of movement y and a drive point located in the front part. The drive point 220 of a self-moving artificial bait fish 1 with head-side drive is in the range of 0.5 to 1.0 times the total length L1, depending on the shape of the self-moving artificial bait fish 1 and the state of movement of the driving means in direction of movement y.

FIG. 10 shows drive means of a magnetic tail-side drive 330 with arrangement of a drive receiving means 310 and a drive excitation 300 with bipolar excitation within a body shell 100 of a self-movable artificial bait fish 1. An electric control current iA(t) flows through a coil 301 alternately in positive and negative direction in this embodiment. The coil 301 thereby generates a magnetic field with alternating polarization N, S concentrated in the core of magnetic material 302. The magnetic field thus generated acts on the drive receiving means 310, which in this embodiment comprises a permanent magnet with a defined permanent magnetic polarity. The north pole N of the drive receiving means 310 is attracted by the south pole S of drive excitation 300 and repelled by the north pole N of drive excitation 300. The drive receiving means 310, which is arranged on the drive lever 312, performs oscillating movements of the drive lever 312 around a drive bearing point 311 in accordance with the electrical control current iA(t) and the magnetic field generated with it, thereby setting a tail fin 102, 103 also in oscillating movement transversely to the direction of movement y and thus drives the self-moving artificial bait fish 1 on the basis of the force component Fyv in the direction of movement y shown as an example in FIG. 1. In this embodiment, the drive bearing point 311 is shown as specially arranged in the transition area 101 of the tail fin 102, 103. Advantageously the elastic material of the body shell 100 and/or the transition area 101 of the tail fin 102, 103 itself forms a drive bearing point 311, which preferably also causes a restoring force on the drive lever 312 into a rest position, which the drive lever assumes when no electrical control current iA(t) flows through the coil 301.

FIG. 11 shows an example of drive means of a magnetic tail-side drive 330 with arrangement of the drive receiving means within the transition area or the tail fin of the self-moving artificial bait fish with bipolar excitation. The north pole N of the drive receiving means 310 is attracted by the south pole S of drive excitation 300 and repelled by the north pole N of drive excitation 300. The drive receiving means 310, which is arranged on the drive lever 312, performs oscillating movements of the drive lever 312 around the drive bearing point 311 in accordance with the electrical control current iA(t) and the magnetic field generated with it, which also sets the tail fin 102, 103 in oscillating movement transversely to the direction of movement y and thus drives the self-moving artificial bait fish 1 on the basis of the force component Fyv in the direction of movement y shown as an example in FIG. 1. In this embodiment, the drive bearing point 311 is shown as specially arranged in the transition area 101 of the tail fin 102, 103. The elastic material of the body shell 100 and/or the transition area 101 of the tail fin 102, 103 and/or the tail fin 102, 103 itself forms a drive bearing point 311, which also produces a restoring force on the drive lever 312 into a rest position, which the drive lever occupies when no electrical control current iA(t) flows through the coil 301.

FIG. 12 shows the drive means of a piezoelectric tail-side drive 330 with bipolar excitation. A piezo element 320 is arranged in the body shell 100 or as shown in FIG. 12 in the transition area 101 of the tail fin 102, 103 clamped on one side, which, when an electrical control voltage uA(t) is applied, moves transversely to the direction of movement y depending on polarity and amount. An oscillating electrical control voltage uA(t) generates an oscillating movement of the piezo element 320. The tail fin 102, 103 is arranged on the piezo element 320. The tail fin 102, 103 is therefore also set in oscillating motion transversely to the direction of motion y and thus drives the self-movable artificial bait fish 1 on the basis of the force component Fyv in the direction of motion y shown in FIG. 1 as an example.

FIG. 13 to FIG. 15 show embodiments each with unipolar excitation by an electric control current iA(t) or by an electric control voltage uA(t). In contrast to bipolar control, in which a deflecting force component is generated alternately in one direction or in the other direction transversely to the direction of movement y by the magnetic field changing in polarity, the generation of a force component only takes place in one direction with unipolar excitation. However, unipolar excitation is less complex than bipolar excitation and can offer advantages in this respect. In order to generate a defined restoring force with unipolar control, an elastic restoring element 304, 324 is arranged in these embodiments, which effects a restoring force on the drive lever 312 into a defined rest position, which the drive lever assumes when no electrical control current iA(t) flows through the coil 301. In the case of a piezoelectric actuator, the piezo element returns to a neutral position even if no electrical control voltage uA(t) is applied. Optionally, an additional restoring element 324 can be provided to increase the reset force of the piezo elements 320.

Preferably, the elastic material of the body shell 100 and/or the transition area 101 of the tail fin 102, 103 and/or the tail fin 102, 103 itself forms an elastic restoring element 304, 324, which causes a restoring force to a defined rest position on the drive lever 312 or the piezo element 320 into a rest position, which the drive lever or the piezo element 320 assumes when no electrical control current iA(t) flows through the coil 301 or no electrical control voltage uA(t) is applied to the piezo element 320.

The waveform, frequency, amplitude and, if applicable, an offset in the electrical control voltage uA(t) or in the electrical control current iA(t) is determined by the electronic control unit 410 by controlling drive excitation 300. Any curve shapes, such as sine, rectangle, pulse, triangle, sawtooth or other periodic curve shapes are possible, which the drive receiving means follows according to the magnetic force field generated with it, in order to simulate, according to the invention, with a movement course of the drive that is as true to nature as possible, as it corresponds to the movement course of a natural prey fish in a normal, in a flight-like or in a sick movement situation. These include optionally via interface 460 adjustable or programmable or permanently stored, via the controller retrievable differently modulated sequences of the electrical control voltage uA(t) or the electrical control current iA(t). Corresponding curves are advantageously programmable and can be downloaded from the Internet and transferred to the electronic control unit 410 via an interface 460 of the artificial bait fish 1.

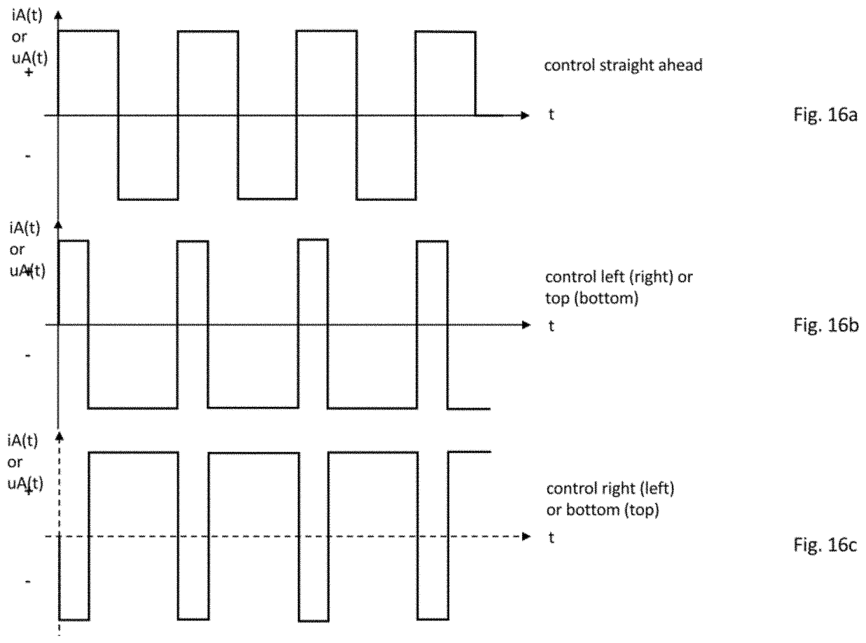

FIG. 16a shows, by way of example, a bipolar signal characteristic of a periodic control voltage uA(t) or a periodic excitation current iA(t) during symmetrical movement in the direction of movement y of a tail-side drive 330 for a temporally symmetrical curve characteristic, FIG. 16b exemplifies for a temporally asymmetrical curve a bipolar signal curve of a periodic control voltage uA(t) or of a periodic excitation current iA(t) in the case of asymmetrical movement with respect to a direction of movement y of a tail-side drive 330 with direction control on the left, FIG. 16c shows, as an example of a temporally asymmetrical curve, a bipolar signal curve of a periodic control voltage uA(t) or a periodic excitation current iA(t) in the case of asymmetrical movement with respect to a direction of movement y of a tail-side drive 330 with direction control on the right. By changing the duty cycle, the duration of the tail fin deflection changes asymmetrically in one or the other direction in this example. On the one hand, this changes the left-hand or right-hand force component Fvyi, or, via the time integral, the left-hand or right-hand work of the drive, and on the other hand, due to the longer dwell time of the tail fin 102, 103 on one or the other side of the deflection, a directional control takes place via an additional force component, which is caused by the surrounding water 3 passing by the respective deflected tail fin 102, 103.

In the case of a vertically aligned tail fin 102, control in the x-direction to the left or right takes place in this way. In the case of a horizontally oriented tail fin 103 a control in z-direction upwards or downwards takes place in this way.

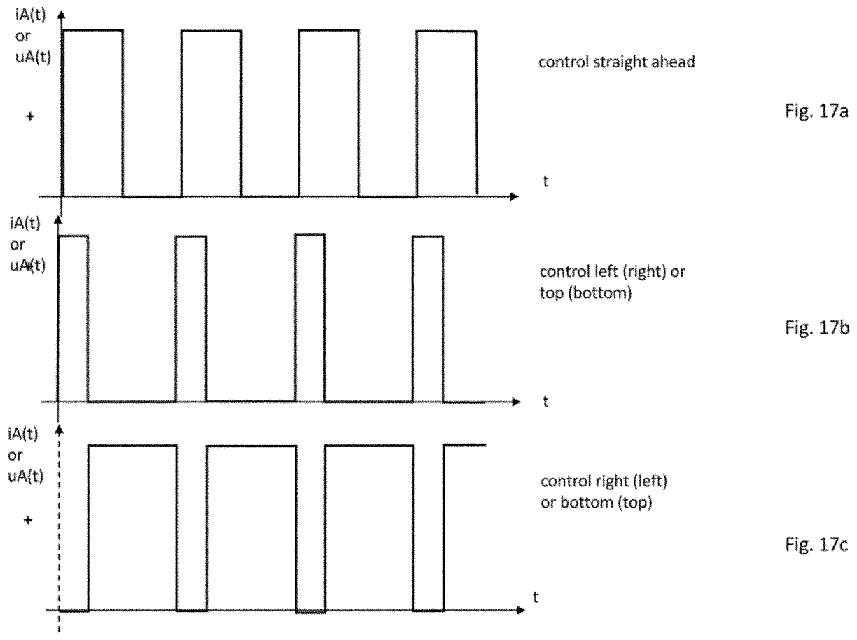

FIG. 17a to FIG. 17c show examples of comparable control options with periodic unipolar control. By changing the duty cycle as an example of a temporally symmetrical or asymmetrical curve progression, the duration of the tail fin deflection in one or the other direction also changes asymmetrically in this example, starting from a symmetrical control and position of the tail fin. On the one hand, this changes the left-hand or right-hand force component Fvyi, or the left-hand or right-hand work of the drive via the time integral, and on the other hand, due to the longer dwell time of the tail fin 102, 103 on one or the other side of the deflection, a directional control takes place via an additional force component which is caused by the surrounding water 3 passing the tail fin 102, 103 deflected in each case. In the case of a vertically aligned tail fin 102, control in the x-direction to the left or right takes place in this way. In the case of a horizontally oriented tail fin 103, control in the z-direction takes place upwards or downwards in this way.

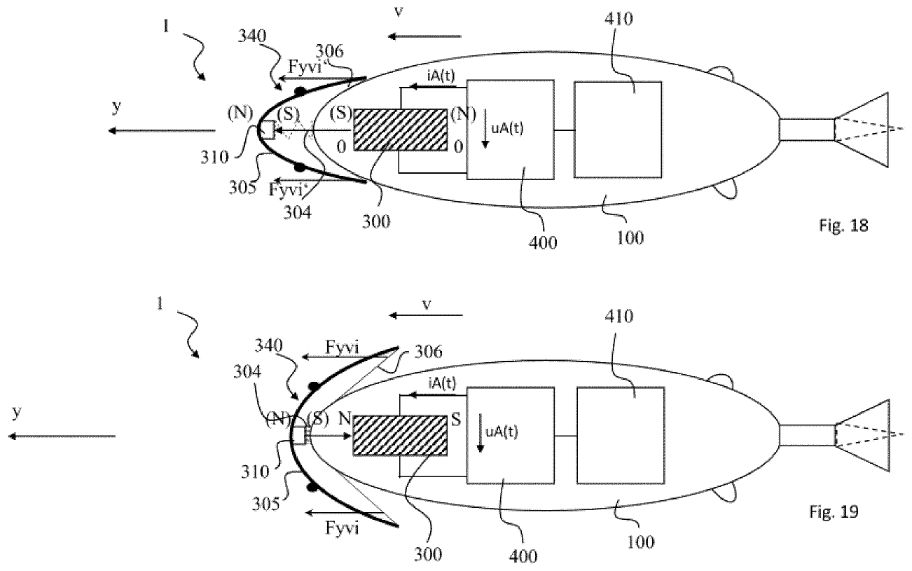

FIG. 18 represents a self-moving artificial bait fish with magnetic drive on the head side in the jellyfish-like stretched out state and FIG. 19 in the jellyfish-like contracted state.

In this embodiment, the head-side drive is an electromagnet comprising a coil 301 and optionally a magnetic core 302 (see FIG. 10 and FIG. 13) as drive excitation 300 with periodic, electrically unipolar or bipolar control by a drive driver 400 and controlled by signals from the electronic control unit 410. The electric drive driver 400 generates an electric current flow iA(t) in the coil 301 of the electromagnet of drive excitation 300, which generates a periodic magnetic field which can be controlled with a defined north(N)-south(S) polarization for unipolar control and with alternating north(N)-south(S) polarization for bipolar control.

The magnetic field generated by the electromagnet exerts an alternating force in the direction of movement y on an elastic drive cap 305 via a drive receiving means 310. The elastic drive cap 305 is thus set directly into oscillating motion and generates force components Fyvi′ directed in the direction of motion y when the elastic drive cap 305 of the self-moving artificial bait fish 1 is pushed away from the surrounding water 3 and force components Fyvi′ directed in the direction of motion y when recoil is generated by displacement of water components. The force component Fyv resulting from the force components Fyvi and Fyvi′ drives the self-moving artificial bait fish 1 at drive point 220 (see FIG. 2 and FIG. 9) in direction of movement y. This creates a natural jelly-like movement of the self-moving artificial bait fish 1 without additional unnatural mechanical vibrations, for example due to commutation or eccentric movement.

The embodiment shows in FIG. 18 the jelly-like head part of the self-moving artificial bait fish 1 with extended elastic drive cap 305 The elastic drive cap 305 comprises an elastic material such as plastic, in particular elastomers, rubber or silicone, with a defined modulus of elasticity in the range between 0.5 MPa to 100 MPa, or a Shore hardness A according to DIN ISO 7619-1 in the range from 5 to 90 Shore hardness A, preferably in the range from 10 to 60 Shore hardness A. The elastic drive cap 305 nestles against the body shell 100 of the self-moving artificial bait fish 1 when stretched out and offers a low flow resistance in the direction of movement y in this condition.

The head-side drive 340 comprises in the head part of the self-moving artificial bait fish 1 a magnetic, preferably a permanent magnetic drive receiving means 310, which is separated from the poles of the electromagnet of the drive excitation 300 via an air gap of pole shoes or if no core is used. With bipolar control, the drive receiving means 310 is pushed forward by a mutually repellent polarity of the drive receiving means 310 (S) and the drive excitation 300 (S) and optionally additionally by an elastic or restoring element 304, whereby the elastic drive cap 305 is brought into a defined position in the extended state. Advantageously, the restoring element comprises part of the elastic body shell 100, for example a circumferential elastic sealing skin 306, which is arranged between the elastic drive cap 305 and the body shell 100.

With optional unipolar excitation, the drive receiving means 310 comprises magnetic material without permanent internal alignment of the magnetic field or permanent magnetic material with defined permanent polarity. In the case of unipolar excitation, an elastic or restoring element 304 is provided as a restoring element into a defined rest position. Preferably, the restoring element comprises part of the elastic body shell 100, for example a circumferential elastic sealing skin 306, which is arranged between the elastic drive cap 305 and the body shell 100.

FIG. 19 shows the magnetic drive on the head side in a jellyfish-like contracted state. The elastic drive cap 305 moves outwards and opens to a defined extent. This creates an area between the elastic drive cap 305 and the body shell 100 that is sealed by the circumferential elastic sealing skin 306 and moves backwards in the surrounding water 3 against the direction of movement y due to the movement of the drive receiving means 310 towards the drive excitation 300, thereby repulsing the self-moving artificial bait fish 1 from the surrounding water 3 with the force components Fyvi and driving it in the direction of movement y.

During the next stretching movement of the elastic drive cap, the area sealed by the circumferential elastic sealing skin 306 shoots out between the elastic drive cap 305 and the body shell 100 and a portion of the surrounding water 3 is pressed out to the rear. The self-moving artificial bait fish 1 is rejected by the surrounding water 3 with further force components Fyvi′ generated by recoil. With a force component Fyv resulting from the force components Fyvi and Fyvi′ at drive point 220 (see FIG. 2 and FIG. 9), the self-moving artificial bait fish 1 is driven in the direction of movement y.

Advantageously, the drive driver 400 together with the control signals of the electronic control unit 410 with a magnetically moving oscillating jelly-like head end controls the movement of the elastic drive cap 305 by a variable control of the drive excitation with regard to the frequency and/or the amplitude and/or the polarity or switches it off or on temporarily. The frequency and/or amplitude determines the number of deflections per time unit of extension and contraction of the jellyfish-like head end. This determines the speed of the forward movement on the one hand and the type of movement on the other. In the case of a head end drive with magnetically moving oscillating jellylike elastic drive cap 305, the amplitude and/or frequency of the jelly-like head end determines the force of the forward directed force Fyv. For example, a distinction can be made between the control of a normal swimming movement and an escape-like swimming movement.

FIG. 20 shows the situation of an angler 2 with rod assembly 10, 11, 12 and a self-moving artificial bait fish 1 introduced into a water body 3. The rod assembly comprises a winding device 12, a fishing rod 11 and a connecting cord 10 between the angler 2 and the self-moving artificial bait fish 1. In the example shown, the self-moving artificial bait fish 1 moves at a relative speed v in the direction y in the surrounding water 3 and drags the connecting cord 10 behind it. In practice, the experienced angler 2 will make sure that the connecting cord 10 is sufficiently tightly guided in order to be able to strike the angler assembly in the event of a bite by a fish to be caught, i.e. by a jerky movement of the connecting cord 10 to ensure that a catch hook of a bait is fixed in the fish to be caught.

With the same method, namely the jerky or elongated retraction of the connecting cord 10, for example by lifting the tip of the fishing rod 11 or by pulling the connecting cord 10, mechanical control signals are optionally sent from angler 2 to the self-movable artificial bait fish 1.

### REFERENCE NUMBER LIST

1 self-moving artificial bait fish
2 anglers
3 surrounding water
10 Connecting cord to the angler
11 fishing rod
12 winding device
100 body shell
101 transition area of the tail fin
102 vertically oriented tail fin
103 horizontally oriented tail fin
110 catch hook
111 catch hook reinforcement
120; 120′ rudder
121 right elevator
122 left elevator
130; 130′ fasteners
200 shape centre of gravity/mould centre of gravity
210 center of gravity
220 drive point
230 fixing point
250 plumb axis
300 drive excitation
301 coil
302 core of magnetic material
304 elastic restoring element
305 Elastic drive cap
306 circumferential elastic sealing skin
310 drive receiving means
311 drive bearing point
312 drive lever
320 piezo element
324 elastic restoring element
330 tail-side drive
340 head-side drive
400 drive driver
410 electronic control unit
420 energy source
430 cord sensor
431 acceleration sensor
440 artificial swim bladders
450 manually operated control actuator
460 interface
y forward direction of movement
x horizontal direction right/left across the direction of movement y
z vertical direction up/down across the direction of movement y
v Speed of movement in the direction of movement y, relative to surrounding water
L1 total length from posterior extremity to anterior extremity of the self-moving artificial bait fish.
Fyvi; Fyvi′ single force component directed forward in y-direction
Fyv forward in y-direction sum of the force components at the drive point
Fyr force component in the fixing point directed against the direction of movement y
dkrit vector of the distance between drive point and attachment point
uA(t) electrical control voltage
iA(t). electrical control current

1.-15. (canceled)

16. A self-moving artificial bait fish (1), comprising:
control means,
a tail-side drive (330), and
a drive point (220) whose position in a direction of movement (y) starting from a rear extremity at a tail end (5) is in a range of 0 to 0.5 times a total length (L1) from the rear extremity at the tail end (5) to a front extremity at a head end (6),
wherein the control means comprises a fastening means (130, 130′) for fastening a connecting cord (10) to an angler (2) and
wherein a position of a fixing point (230) on the fastening means (130, 130′) is arrangeable in the direction of movement (y) in a region of the rear extremity at the tail end (5) up to a position behind the position of the drive point (220).

17. The self-moving artificial bait fish (1) according to claim 16,
further comprising an electromagnetic drive comprising a coil (301) with an electrical drive as drive excitation (300) and a magnetic drive receiving means (310),
wherein the electrical drive excitation (300) is periodically driven and the drive receiving means (310) and a tail fin (102, 103) of the tail-side drive (330) are directly set into oscillating movement by a generated magnetic field.

18. The self-moving artificial bait fish (1) according to claim 17,
wherein periodic electrical activation of the drive excitation (300) takes place with a temporally asymmetric curve and the tail fin (102, 103) of the tail-side drive (330) is set into asymmetric oscillating movement.

19. The self-moving artificial bait fish (1) according to claim 16,
further comprising a piezoelectric drive comprising a piezo element (320) with an electrical drive as drive excitation (300),
wherein the electrical drive excitation (300) is periodically driven and the piezo element (320) and a tail fin (102, 103) of the tail-side drive (330) are directly set into oscillating motion.

20. The self-moving artificial bait fish (1) according to claim 19,
wherein periodic electrical activation of the drive excitation (300) takes place with a temporally asymmetric curve and the tail fin (102, 103) of the tail-side drive (330) is set into asymmetric oscillating movement.

21. A self-moving artificial bait fish (1), comprising:
control means;
a head-side drive (340);
head-side drive means; and
a drive point (220) whose position in a direction of movement (y) starting from a rear extremity at a tail end (5) is in a range of 0.5 to 1.0 times a total length (L1) from the rear extremity at the tail end (5) to a front extremity at a head end (6),
wherein the control means comprises at least one fastening means (130, 130′) for fastening a connecting cord (10) to an angler (2), and
wherein a position of a fixing point (230) on the fastening means (130, 130′) is arrangeable in the direction of movement (y) in a region from the rear extremity at the tail end (5) to a position behind the position of the drive point (220).

22. The self-moving artificial bait fish (1) according to claim 21,
wherein the head-side drive (340) has an elastic drive cap (305) comprising
an electromagnetic drive with a coil (301),
an electric drive as drive excitation (300) and
a magnetic drive receiving means (310),
wherein the electrical control of the drive excitation (300) takes place periodically and the magnetic drive receiving element (310) and the elastic drive cap (305) of the head-side drive (340) can be set directly into oscillating movement by a generated magnetic field.

23. The self-moving artificial bait fish (1) according to claim 22,
wherein the elastic drive cap (305) bears against a body of the self-moving artificial bait fish (1) in an extended state of oscillating movement and opens outwards to a defined extent in a contracted state of oscillating movement, in that an alternating force effect can be exerted on the drive receiving means (310) by the magnetic field generated by the electromagnetic drive in the direction of movement (y).

24. The self-moving artificial bait fish (1) according to claim 21,
wherein alternatively further control means (120, 120′, 121, 122, 440) or means for shifting weight are respectively arranged,
wherein the control means (120, 120′, 121, 122, 440) or the means for shifting weight are electrically adjustable via control actuators.

25. The self-moving artificial bait fish (1) according to claim 24,
wherein an electronic control unit (410) is arranged within a body shell (100) of the self-moving artificial bait fish (1) for controlling a drive excitation (300) or the control actuators.

26. The self-moving artificial bait fish (1) according to claim 25,
wherein message detection means (430, 431) are provided in the self-moving artificial bait fish (1) which convert defined changes in a force action (Fyr) of the connecting cord (10) from the self-moving artificial bait fish (1) to the angler (2) or defined changes in a speed (v) of the self-moving artificial bait fish (1) into electrical signals.

27. The self-moving artificial bait fish (1) according to claim 26,
wherein the electronic control unit (410) comprises a decoder for decoding the electrical signals converted by a message detection means (430, 431) and controls control of a drive excitation (300) or the control actuators in response to a decoded message from the angler (2).

28. The self-moving artificial bait fish (1) according to claim 25,
wherein a pressure sensor for detecting a static water pressure of a current diving depth is arranged within the body shell (100) of the self-moving artificial bait fish (1) in conjunction with the electronic control unit (410),
control means (120, 121, 420, 440 103) for controlling the diving depth being controlled by control actuators in conjunction with the electronic control unit (410) such that a certain diving depth predetermined by the angler based on programming of the electronic control unit (410) or in response to a decoded message is durable.

29. The self-moving artificial bait fish (1) according to claim 21,
wherein at least one means for locating is provided in the self-moving artificial bait fish (1) and/or means for dispensing acoustic attractants and/or optical attractants and/or flavour attractants for attracting prey fish.

30. A method for controlling a self-moving artificial bait fish (1), comprising:
providing the self-moving artificial bait fish (1) in accordance with claim 16,
attaching a connecting cord (10) to an angler (2) on a fastener (130, 130′) of the artificial bait fish (1), and
deploying the artificial bait fish (1) in a surrounding water (3),
wherein the artificial bait fish (1) drags the connecting cord (10) to the angler (2) behind its drive point (220) in the direction of movement y due to the position of the fixing point (230).

31. The method for controlling the self-moving artificial bait fish (1) according to claim 30, further comprising the steps of
providing at least one message detection means (430, 431) for detecting tension variations between the self-moving artificial bait fish (1) and the connecting cord (10) to the angler (2) and/or speed variations of the self-moving artificial bait fish (1),
providing a decoder,
coding a message by causing tension variations on the connecting cord (10) to the angler (2) and/or speed variations of the self-moving artificial bait fish (1) by the angler (2) by causing tension variations on the connecting cord (10) to the angler (2) by the angler (2),
decoding of the coded message by the decoder in the self-moving artificial bait fish (1),
performing a control action in response to the decoded message by at least one control actuator and/or the drive of the self-moving artificial bait fish (1).
